(19) United States
(12) Patent Application Publication
(10) Pub. No.: US 2012/0109694 A1
(43) Pub. Date: May 3, 2012

(54) VEHICLE ASSIGNMENT SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/037,133

(22) Filed: Feb. 28, 2011

(30) Foreign Application Priority Data
Oct. 29, 2010 (TW) 99137114

(51) Int. Cl. G06Q 10/00

(52) U.S. Cl. 705/5

(57) ABSTRACT

A method for dispatching a vehicle receives a reservation request sent from a handheld device by a dispatch system, and confirms an available service vehicle nearest to an original position of the handheld device from a vehicle database in the dispatch system. The method further transmits information of the confirmed vehicle to the handheld device, and information of a user of the handheld device to the confirmed vehicle.

### BACKGROUND

1. Technical Field

Embodiments of the present disclosure relate to dispatch technology, and particularly to a vehicle assignment system and method.

2. Description of Related Art

Car service operations frequently, upon receiving a request call from a passenger, dispatch a car by contacting potentially available vehicles by wireless communication. However, if a passenger's location changes, the dispatched vehicle may have difficulty making the pickup. Accordingly, it is inconvenient for the passenger to reserve a vehicle, and it is inefficient for the service center to dispatch the vehicle. Therefore, an efficient method for dispatching a vehicle using a dispatch system is desired.

### BRIEF DESCRIPTION OF THE DRAWINGS

FIG. 1 is a schematic diagram of one embodiment of a dispatch system connected with at least one vehicle.

FIG. 2 is a block diagram of one embodiment of a vehicle assignment system in the dispatch system.

FIG. 3 is a flowchart of one embodiment of a method for dispatching a vehicle using the dispatch system.

FIG. 4 is a schematic diagram of one embodiment of an electronic map.

FIG. 5 is a schematic diagram of one embodiment of a vehicle database.

FIGS. 6A-6C are schematic diagrams of exemplary operating interfaces of a handheld device.

FIG. 7 is a schematic diagram of information for a confirmed vehicle displayed on the handheld device.

FIG. 8 is a schematic diagram of information for a passenger displayed on a screen of the confirmed vehicle.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

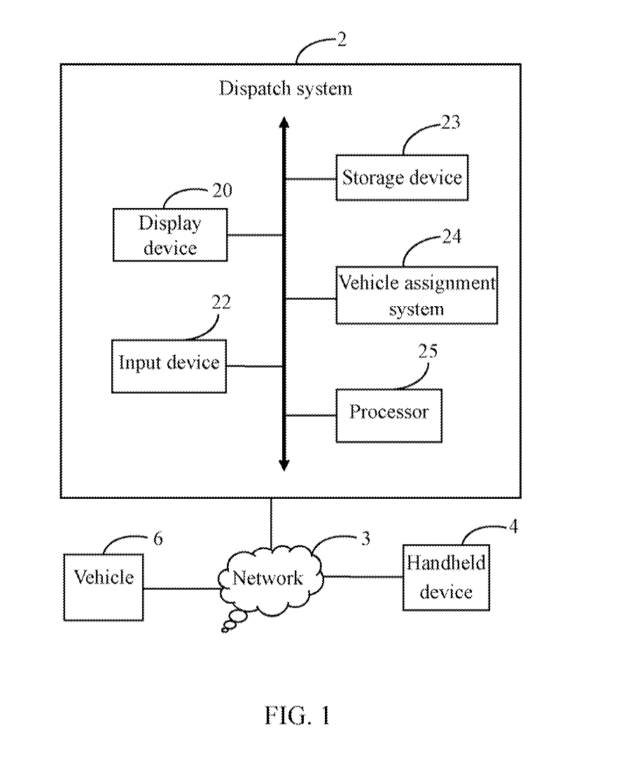

FIG. 1 is a schematic diagram of one embodiment of a dispatch system 2 connected with a handheld device 4 and at least one vehicle 6 through a network 3. In one embodiment, the dispatch system 2 includes a display device 20, an input device 22, a storage device 23, a vehicle assignment system 24, and at least one processor 25. In one embodiment, the vehicle assignment system 24 may be used to confirm an available service vehicle nearest to the handheld device 4 automatically, and transmit updated position information of the handheld device 4 to the confirmed vehicle. In one embodiment, the available service vehicle is a service vehicle which is available to help a user of the handheld device 4 (e.g., a cell phone). A detailed description will be given in the following paragraphs.

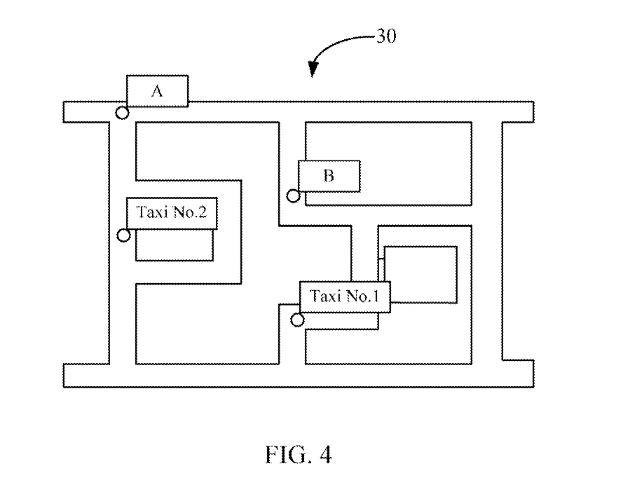

In one embodiment, a global position system (GPS) is installed in the handheld device 4 and the vehicle 6 to determine position information of the handheld device 4 and the taxi 6, and transmit the position information to the dispatch system 2. In one embodiment, the position information includes longitude and latitude of the handheld device 4 or the vehicle 6. An electronic map 30 (as shown in FIG. 4) is installed in the dispatch system 2, handheld device 4, and the vehicle 6 to enable display of the position information.

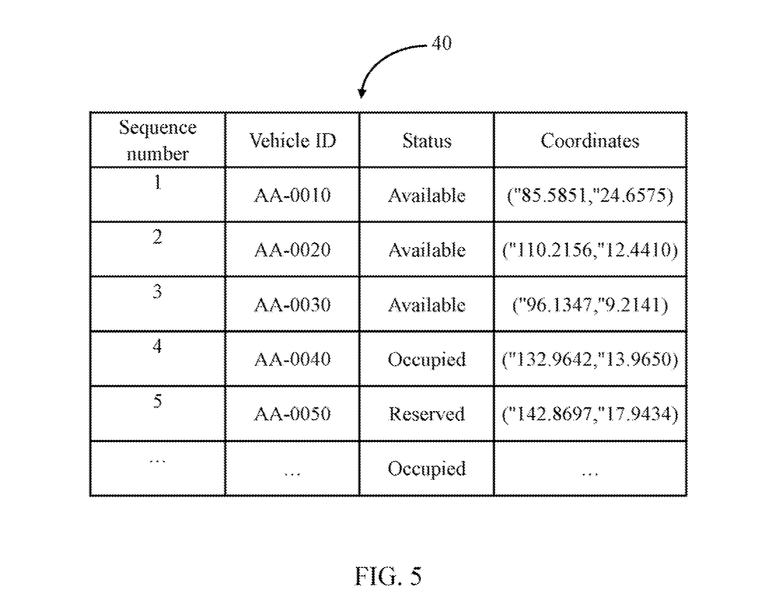

In one embodiment, the display device 20 may display the electronic map 30, and the input device 22 may be a mouse or a keyboard used to input data. A vehicle database 40 is stored in the storage device 23. As shown in FIG. 5, the vehicle database 40 includes, but is not limited to, identification (ID), status, and coordinates for each vehicle. In one embodiment, status of the vehicle 6 can be one of, but is not limited to, available, occupied, and reserved. The vehicle 6 is confirmed to be reserved if enroute to a pickup, occupied if a successful pickup has taken place, available if the vehicle 6 is available to help the user of the handheld device 4.

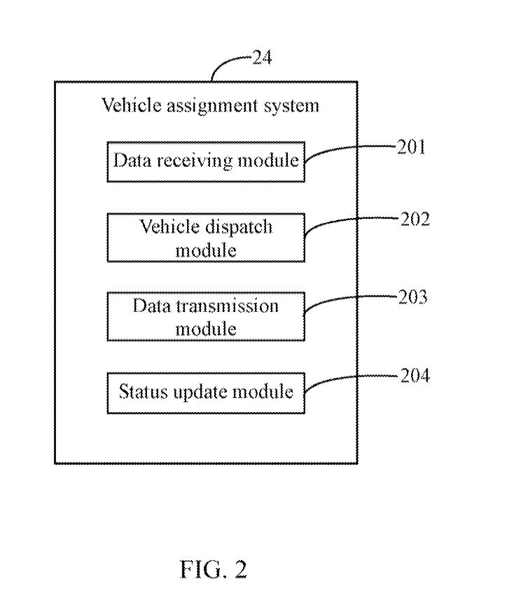

FIG. 2 is a block diagram of one embodiment of the vehicle assignment subsystem 24 in the dispatch system 2. In one embodiment, the vehicle assignment subsystem 24 may include one or more modules, such as a data receiving module 201, a vehicle dispatch module 202, a data transmission module 203, and a status update module 204. The one or more modules may comprise computerized code in the form of one or more programs that are stored in the storage device 23 (or memory). The computerized code includes instructions that are executed by the at least one processor 25 to provide functions for the one or more modules.

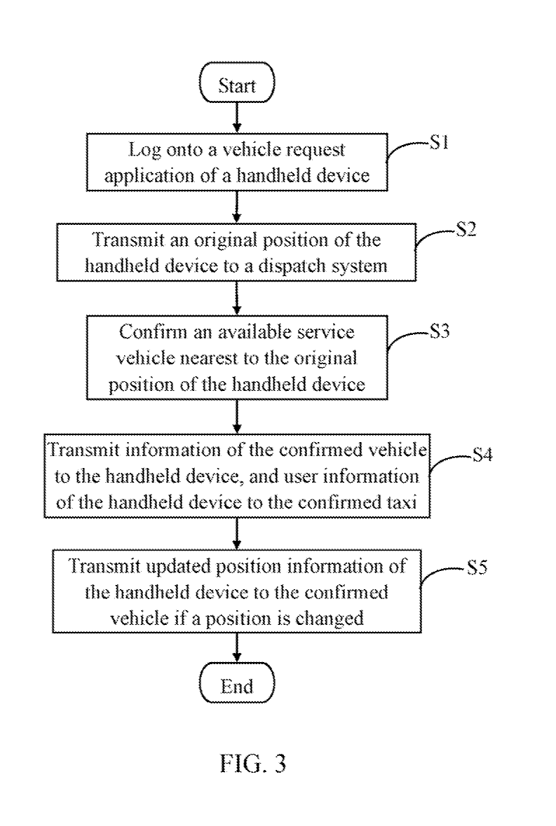

FIG. 3 is a flowchart of one embodiment of a method for dispatching a vehicle using the dispatch system 2. Depending on the embodiment, additional blocks may be added, others removed, and the ordering of the blocks may be changed.

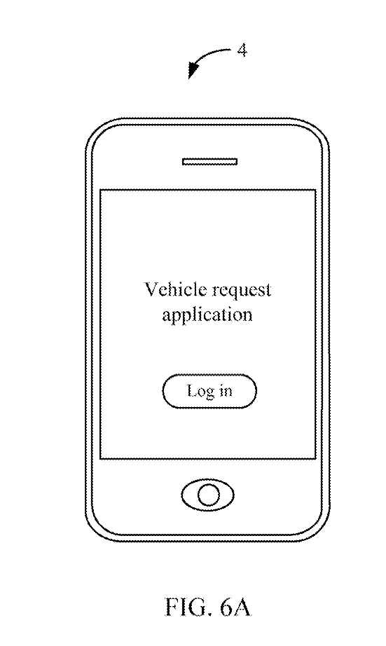

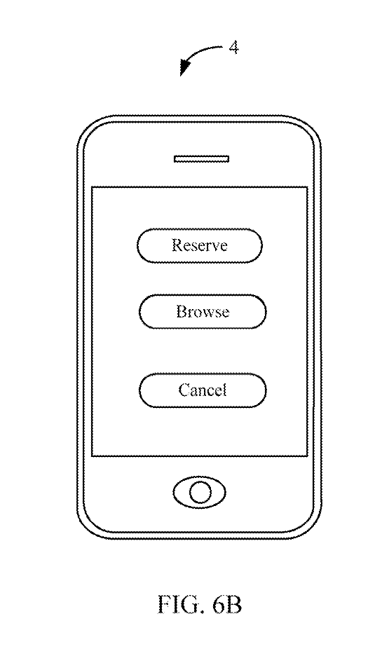

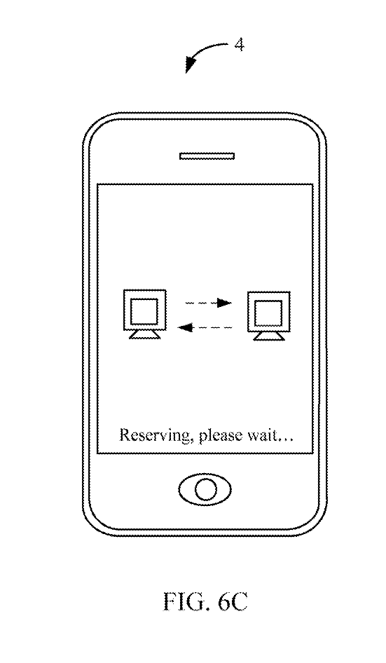

In block S1, a user logs onto a vehicle request application of the handheld device 4 to execute a vehicle request (refers to FIGS. 6A-6C). In one embodiment, the vehicle request application of the handheld device 4 communicates with the vehicle assignment system 24 of the dispatch system 2 through the network 3.

In block S2, the handheld device 4 transmits a reservation request to the dispatch system 2. In one embodiment, the reservation request includes position information of an original position of the handheld device 4 and request details corresponding to the user of the handheld device 4. In some embodiments, the original position may be a current position of the handheld device 4 when the reservation request is sent to the dispatch system 2. The request details may include a name of a passenger, a level of the passenger (e.g., a VIP member), and specified requirements of the passenger.

In block S3, the data receiving module 201 receives the reservation request from the handheld device 4, and confirms availability of an available service vehicle nearest to the original position of the handheld device 4 from the vehicle database 40.

In block S4, the data transmission module 203 transmits information of the confirmed vehicle to the handheld device 4, and transmits user information of the handheld device 4 to the confirmed vehicle. The status update module 204 changes the status of the confirmed vehicle from available to reserved. The user information may include the position information of the original position of the handheld device 4 and request details as noted.

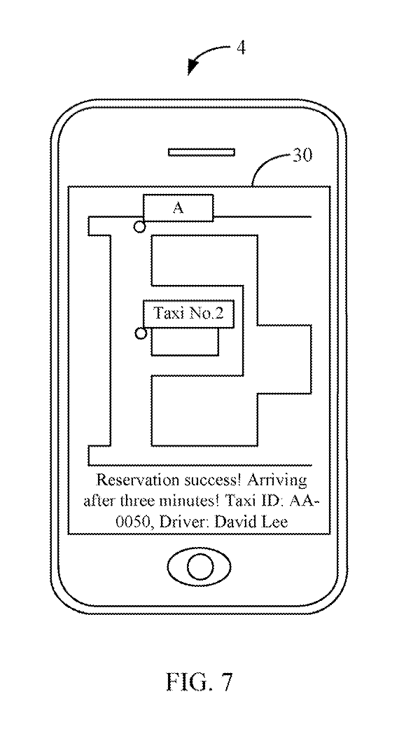

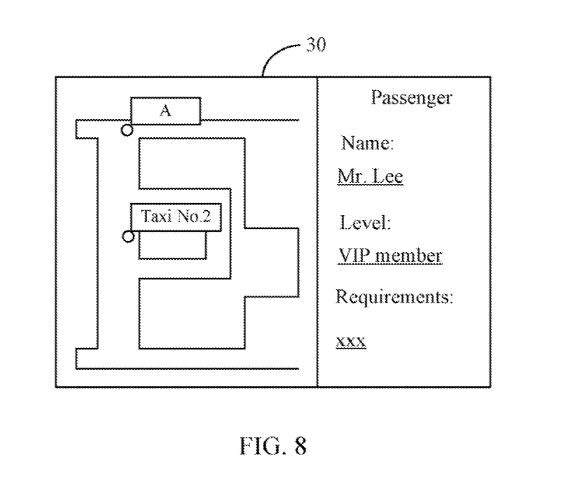

As shown in FIG. 7, the information of the confirmed vehicle may be displayed on the screen of the handheld device 4 upon request. As shown in FIG. 8, the user information may be displayed on a screen of the confirmed vehicle.

In other embodiments, the method may further include, in a block S5, the dispatch system 2 transmitting updated position information of the handheld device 4 to the confirmed vehicle if a position of the handheld device 4 is changed before the control computer 2 receives a starting command of charging fees from the confirmed vehicle. In one embodiment, the global position system of the handheld device 4 detects updated position information of the handheld device 4 after a preset time interval (e.g., five seconds), and transmits the updated position information of the handheld device 4 to the dispatch system 2. The dispatch system 2 calculates a distance between the updated position information of the updated position of the handheld device 4 and the position information of the original position of the handheld device 4, and determines that the position of the handheld device 4 has changed if the calculated distance is greater than a preset value (e.g., five meters).

In other embodiments, if the dispatch system 2 receives a starting command of charging fees (i.e., notification of occupancy) from the confirmed vehicle, the status update module 204 changes the status of the confirmed vehicle from reserved to occupied. If the dispatch system 2 receives an ending command of charging fees (i.e., notification of availability) from the confirmed vehicle, the status update module 204 changes the status of the confirmed vehicle from occupied to available.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for dispatching a vehicle, the method comprising:
receiving a reservation request sent from a handheld device by a dispatch system, the reservation request comprising position information of an original position of the handheld device;
confirming an available service vehicle nearest to the original position of the handheld device from a vehicle database in the dispatch system; and
transmitting information of the confirmed vehicle to the handheld device, and transmitting information of a user of the handheld device to the confirmed vehicle.

2. The method according to claim 1, wherein the position information comprises longitude and latitude of the original position of the handheld device.

3. The method according to claim 1, wherein the reservation request further comprises request details corresponding to the user of the handheld device, the request details comprising a name of a passenger, a level of the passenger, and specified requirements of the passenger.

4. The method according to claim 1, further comprising: changing a status of the confirmed vehicle from available to reserved upon the condition that the confirmed vehicle is found.

5. The method according to claim 4, further comprising: changing the status of the confirmed vehicle from reserved to occupied upon the condition that the dispatch system receives notification of occupancy from the confirmed vehicle.

6. The method according to claim 5, further comprising: changing the status of the confirmed vehicle from occupied to the available upon the condition that the dispatch system receives notification of availability from the confirmed vehicle.

7. The method according to claim 1, further comprising: transmitting updated position information of a updated position of the handheld device to the confirmed vehicle upon the condition that a position of the handheld device is changed before the dispatch system receives notification of occupancy from the confirmed vehicle.

8. The method according to claim 7, wherein the position of the handheld device is determined to be changed by:
calculating a distance between the updated position of the handheld device and the original position of the handheld device; and
determining that the position of the handheld device is changed upon the condition that the calculated distance is greater than a preset value.

9. A dispatch system for dispatching a vehicle, comprising:
a storage device;
at least one processor; and
one or more modules that are stored in the storage device and are executed by the at least one processor, the one or more modules comprising instructions:
to receive a reservation request sent from a handheld device by the dispatch system, the reservation request comprising position information of an original position of the handheld device;
to confirm an available service vehicle nearest to the original position of the handheld device from a vehicle database in the dispatch system; and
to transmit information of the confirmed vehicle to the handheld device, and transmit information of a user of the handheld device to the confirmed vehicle.

10. The dispatch system according to claim 9, wherein the reservation request further comprises request details corresponding to the user of the handheld device, the request details comprising a name of a passenger, a level of the passenger, and specified requirements of the passenger.

11. The dispatch system according to claim 9, wherein the one or more modules further comprise instructions: changing a status of the confirmed vehicle from available to reserved upon the condition that the confirmed vehicle is found.

12. The dispatch system according to claim 11, wherein the one or more modules further comprise instructions: changing the status of the confirmed vehicle from reserved to occupied upon the condition that the dispatch system receives notification of occupancy from the confirmed vehicle.

13. The dispatch system according to claim 12, wherein the one or more modules further comprise instructions: changing the status of the confirmed vehicle from occupied to available upon the condition that the dispatch system receives notification of availability from the confirmed vehicle.

14. The dispatch system according to claim 9, wherein the one or more modules further comprise instructions: transmitting updated position information of a updated position of the handheld device to the confirmed vehicle upon the condition that a position of the handheld device is changed before the dispatch system receives notification of occupancy from the confirmed vehicle.

15. The dispatch system according to claim 14, wherein the position of the handheld device is determined to be changed by:
calculating a distance between the updated position of the handheld device and the original position of the handheld device; and
determining that the position of the handheld device is changed upon the condition that the calculated distance is greater than a preset value.

16. A non-transitory storage medium having stored thereon instructions that, when executed by a processor of a dispatch system, causes the processor to perform a method for dispatching a vehicle, the method comprising:
receiving a reservation request sent from a handheld device by a dispatch system, the reservation request comprising position information of an original position of the handheld device;
confirming an available service vehicle nearest to the original position of the handheld device from a vehicle database in the dispatch system; and
transmitting information of the confirmed vehicle to the handheld device, and transmitting information of a user of the handheld device to the confirmed vehicle.

17. The non-transitory storage medium according to claim 16, wherein the reservation request further comprises request details corresponding to the user of the handheld device, the request details comprising a name of a passenger, a level of the passenger, and specified requirements of the passenger.

18. The non-transitory storage medium according to claim 16, wherein the method further comprises: changing a status of the confirmed vehicle from available to reserved upon the condition that the confirmed vehicle is found.

19. The non-transitory storage medium according to claim 18, wherein the method further comprises: changing the status of the confirmed vehicle from reserved to occupied upon the condition that the dispatch system receives notification of occupancy from the confirmed vehicle.

20. The non-transitory storage medium according to claim 19, wherein the method further comprises: changing the status of the confirmed vehicle from occupied to available upon the condition that the dispatch system receives notification of availability from the confirmed vehicle.
